(19) United States
(12) Patent Application Publication
(10) Pub. No.: US 2026/0100525 A1
(43) Pub. Date: Apr. 9, 2026

(54) TERMINAL BLOCK

(71) Applicant: Yazaki Corporation, Tokyo (JP)

(72) Inventors: Daisuke YAMANASHI, Shizuoka (JP); Jumpei HAYASHI, Shizuoka (JP)

(73) Assignee: Yazaki Corporation, Tokyo (JP)

(21) Appl. No.: 19/349,444

(22) Filed: Oct. 3, 2025

(30) Foreign Application Priority Data
Oct. 7, 2024 (JP) 2024-175548

(51) Int. Cl. H01R 9/24; H01R 4/34; H01R 9/22

(52) U.S. Cl. CPC H01R 9/2416; H01R 4/34; H01R 9/223

(57) ABSTRACT

An object is to provide a terminal block that can properly reduce scattering of foreign matters. A terminal block includes a bus bar extending in an axial direction and connected to an external terminal, a nut into which a bolt is screwed, the bolt fastening the bus bar and the external terminal along a fastening direction that intersects the axial direction, and a housing including a nut holding portion that holds the nut and holding the bus bar.

### CROSS-REFERENCE TO RELATED APPLICATION(S)

The present application claims priority to and incorporates by reference the entire contents of Japanese Patent Application No. 2024-175548 filed in Japan on Oct. 7, 2024.

### BACKGROUND OF THE INVENTION

### 1. Field of the Invention

The present invention relates to a terminal block.

### 2. Description of the Related Art

The related art for a terminal block includes, for example, Japanese Patent Application Laid-open No. 2023-001934.

Japanese Patent Application Laid-open No. 2023-001934 discloses a terminal block including a housing having through holes, holding bus bars as terminals connected to external terminals, and having a cylindrical storage chamber in an axial direction of the through holes, nuts stored in the storage chamber, and a holder attached to the housing with a support portion supporting the nuts. The holder has a recess that is formed in a recessed shape from the support portion. The external terminals and the bus bars are fastened together by bolts that are inserted through the through holes of the bus bars and screwed into the nuts. The nut is positioned to be contactable with the bus bar or the support portion before being screwed with the bolt, and is separated from the support portion and contacts with the bus bar after being screwed with the bolt. Chips generated when the bolt and the nut are screwed together are stored in the recess of the holder.

However, in such a terminal block, for example, the recess to store foreign matters such as chips generated when the bolt and the nut are screwed together is surrounded by the nut and the storage chamber in which the nut is stored, but there is room for further improvement in terms of preventing the scattering of foreign matters.

### SUMMARY OF THE INVENTION

The present invention has been made to solve the problem described above and an object of the present invention is to provide a terminal block that can properly reduce scattering of foreign matters.

In order to achieve the above mentioned object, a terminal block according to one aspect of the present invention includes a bus bar extending in an axial direction and connected to an external terminal; a nut into which a bolt is screwed, the bolt fastening the bus bar and the external terminal along a fastening direction that intersects the axial direction; and a housing including a nut holding portion that holds the nut, and holding the bus bar, wherein the nut holding portion includes: a nut placement surface formed in an annular shape around the fastening direction, with the nut being placed on the nut placement surface; and a bottomed recess that is formed in a recessed shape from the nut placement surface to an opposite side of the bus bar in the fastening direction and is provided with a peripheral surface connected to an inner edge of the nut placement surface formed in an annular shape.

### BRIEF DESCRIPTION OF THE DRAWINGS

FIG. 1 is a perspective view illustrating a terminal block according to an embodiment.

FIG. 2 is an exploded perspective view illustrating the terminal block according to the embodiment.

FIG. 3 is a plan view illustrating a nut holding portion of the terminal block according to the embodiment.

FIG. 4 is a cross-sectional view taken along line IV-IV in FIG. 1.

FIG. 5 is a cross-sectional view taken along line V-V in FIG. 1.

### DETAILED DESCRIPTION OF THE PREFERRED EMBODIMENTS

The following is a detailed description of an embodiment according to the present invention based on the drawings. Note that this invention is not limited by this embodiment. In addition, components in the following embodiment include those that are substitutable and easy to substitute for those skilled in the art, or those that are substantially the same.

### EMBODIMENT

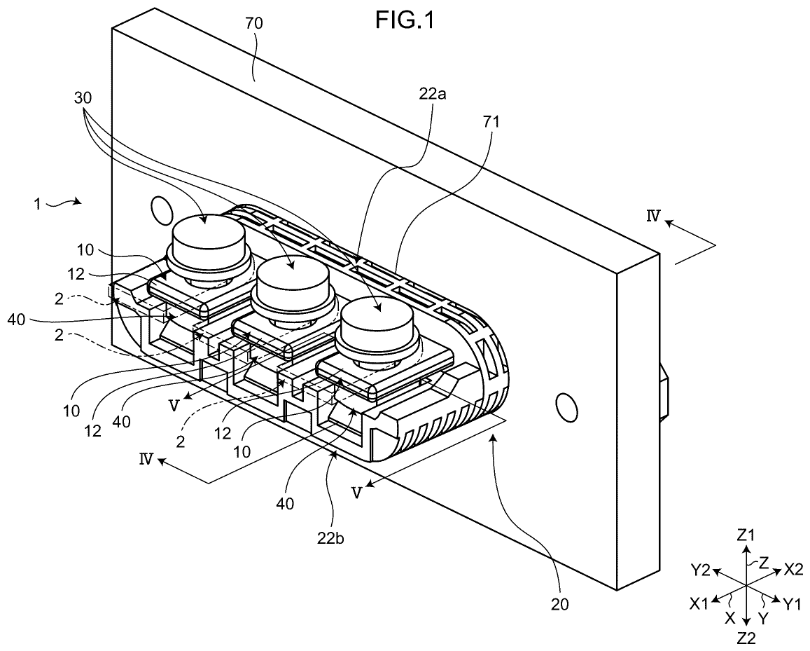

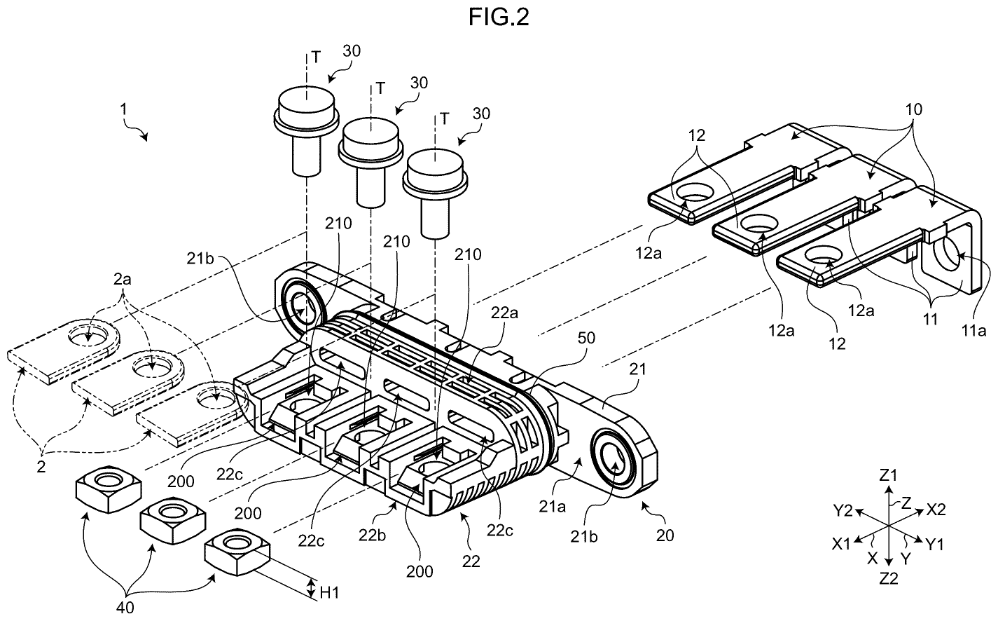

A terminal block 1 of the present embodiment illustrated in FIGS. 1 and 2 is mounted on a vehicle such as an electric vehicle or a hybrid vehicle, is attached to a mounting target 70, and relays an electrical connection between a first device and a second device (not illustrated). The terminal block 1 of the present embodiment includes a plurality of bus bars 10, which are three, and external terminals of the first device are electrically connected to first connection portions 11 provided at one ends of the plurality of bus bars 10. In the terminal block 1 of the present embodiment, external terminals 2 of the second device indicated by double-dotted lines are electrically connected to second connection portions 12 provided at the other ends of the plurality of bus bars 10. The first device is, for example, one of a motor and an inverter, and the second device is, for example, the other of the motor and the inverter. The terminal block 1 is not limited to this example and may be used, for example, for relaying between the first or second device and a wiring material, relaying between a wiring material and a wiring material, or the like.

In the following description, a direction in which the bus bars 10 extend is referred to as an axial direction X, a direction orthogonal to the axial direction X and in which the plurality of bus bars 10 are arranged is referred to as a width direction Y, and a direction orthogonal to each of the axial direction X and the width direction Y is referred to as a height direction Z. One side in the axial direction X is referred to as one side X1 and the other side is referred to as the other side X2. Similarly, in the width direction Y, one side is referred to as Y1 and the other side is referred to as Y2, and in the height direction Z, one side is referred to as Z1 and the other side is referred to as Z2.

The bus bar 10 has the first connection portion 11 and the second connection portion 12 that is formed by bending at a right angle from the first connection portion 11. Each part is formed three-dimensionally as a single piece in an approximately L-shape by applying various processes such as bending to a metal material such as a sheet metal material to match the shape corresponding to each part. The first connection portion 11 is formed in a plate shape extending in the height direction Z and with a plate surface oriented in the axial direction X. The second connection portion 12 is formed in a plate shape extending in the axial direction X and with a plate surface oriented in the height direction Z. On the other side Z2 in the height direction Z, the first connection portion 11 is formed with a connection hole 11a that penetrates in the axial direction X. Similarly, on the one side X1 in the axial direction X, the second connection portion 12 is formed with a connection hole 12a that penetrates in the height direction Z. The external terminal of the aforementioned first device is connected to the connection hole 11a of the first connection portion 11, and the external terminal 2 of the aforementioned second device is connected to the connection hole 12a of the second connection portion 12.

The external terminal 2 is formed in a plate shape approximately parallel to the second connection portion 12 and is formed with a connection hole 2a that penetrates in the height direction Z. The external terminal 2 and the second connection portion 12 of the bus bar 10 are connected by a bolt 30 inserted through the connection hole 2a of the external terminal 2 and the connection hole 12a of the second connection portion 12 and screwed into a nut 40 held in a housing 20. The direction of the axis of the bolt 30 is set as a fastening direction T for fastening the external terminal 2 and the bus bar 10. The fastening direction T is a direction along the height direction Z. The nut 40 is a square nut.

The housing 20 has a housing body 21 and a bus bar holding portion 22 including a plurality of nut holding portions 200, and is integrally formed of an insulating synthetic resin material or the like. The housing body 21 is formed in an approximately rectangular plate shape with the width direction Y as a longitudinal direction. A face of the housing body 21 on the one side X1 in the axial direction X is an approximately flat mounting surface 21a that is in contact with a face of the mounting target 70 on the other side X2 in the axial direction X. Mounting holes 21b are provided near edges of the housing body 21 on the one side Y1 and the other side Y2 in the width direction Y, respectively. The mounting hole 21b is a hole that penetrates in the axial direction X, and a bolt (not illustrated) is inserted into the mounting hole 21b, so that the terminal block 1 is fixed to the mounting target 70 via the mounting hole 21b.

The bus bar holding portion 22 of the housing 20 is provided at approximately the center of the housing body 21 in the width direction Y. The bus bar holding portion 22 is formed to protrude from the mounting surface 21a of the housing body 21 toward the one side X1 in the axial direction X. The bus bar holding portion 22 holds the plurality of bus bars 10 extending in the axial direction X to intersect the mounting surface 21a. A base 22a, which is the housing body 21 side of the bus bar holding portion 22, is formed in an approximately columnar shape with an approximately rounded rectangular cross section extending in the axial direction X with the width direction Y as the longitudinal direction. On the other side X2 in the axial direction X, the base 22a is connected to the housing body 21.

The base 22a is provided with a plurality of bus bar insertion portions 22c represented as flat holes that penetrate the housing body 21 from a face of the base 22a on the one side X1 in the axial direction X to the other side X2. The second connection portion 12 of each bus bar 10 is fixed to each bus bar insertion portion 22c by insert molding. Thus, in the present embodiment, no terminal packing is provided between the second connection portion 12 of the bus bar 10 and the bus bar insertion portion 22c; however, each bus bar insertion portion 22c may be formed as an insertion hole to provide a terminal packing. A seal member 50 is provided in an annular groove on the outer periphery of the base 22a of the bus bar holding portion 22.

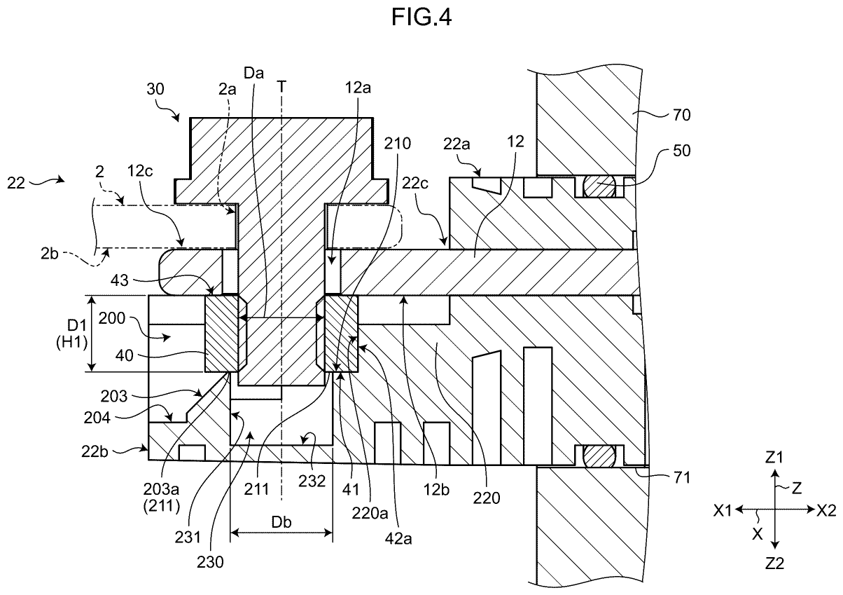

The housing 20 is mounted in a state in which the bus bar holding portion 22 is inserted into a mounting hole 71 penetrating the mounting target 70 and the base 22a is positioned in the mounting hole 71. At this time, the seal member 50 seals the inner peripheral surface of the mounting hole 71 of the mounting target 70 and the outer periphery of the base 22a of the housing 20 (see FIG. 4).

The bus bar holding portion 22 is provided with a tip 22b having an approximately flat plate shape on the one side X1 in the axial direction X at the base 22a. The tip 22b is provided with the plurality of nut holding portions 200. Each nut holding portion 200 is provided for each bus bar 10. In the present embodiment, the nut holding portions 200 are integrally formed with the housing 20.

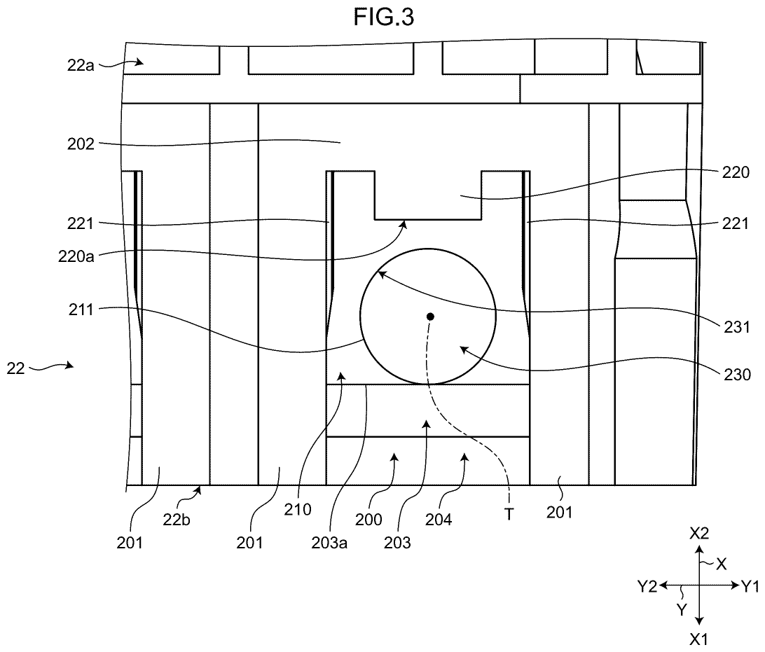

As illustrated in FIG. 3, the nut holding portion 200 is formed in an approximately annular shape around the fastening direction T and is provided with a nut placement surface 210 that is flat to allow the nut 40 to be placed. On the one side Y1 and the other side Y2 in the width direction Y, the nut placement surface 210 is provided with two side walls 201 with wall surfaces oriented in the width direction Y. On the other side X2 in the axial direction X, the two side walls 201 are connected by a rear wall 202 whose wall surface is oriented in the axial direction X. The rear wall 202 has a rectangular parallelepiped-shaped nut pressing portion 220 protruding toward the one side X1 in the axial direction X.

The wall surfaces of the two side walls 201 on the nut placement surface 210 side are provided with nut pressing protrusions 221 protruding toward the nut placement surface 210 and facing each other in the width direction Y. The nut pressing protrusion 221 is long along the axial direction X. The nut pressing protrusion 221 is tapered on the one side X1 in the axial direction X. Thus, the nut 40 is inserted from the one side X1 in the axial direction X and fixed by being positioned and interposed by two nut pressing protrusions 221 in the width direction Y. That is, the two nut pressing protrusions 221 as nut-fixing portions fix the nut 40 in a state in which the nut 40 is in contact with the nut placement surface 210. The nut 40 inserted from the one side X1 in the axial direction X is in contact with the nut pressing portion 220 and is positioned in the axial direction X.

On the one side X1 of the axial direction X in the nut placement surface 210, an inclined surface 203 is provided, and further on the one side X1 of the inclined surface 203, a base surface 204 is provided. The base surface 204 is a flat surface parallel to the nut placement surface 210 and is located on the other side Z2 in the height direction Z from the nut placement surface 210. The inclined surface 203 is inclined from the one side Z1 to the other side Z2 in the height direction Z along the one side X1 from the other side X2 in the axial direction X.

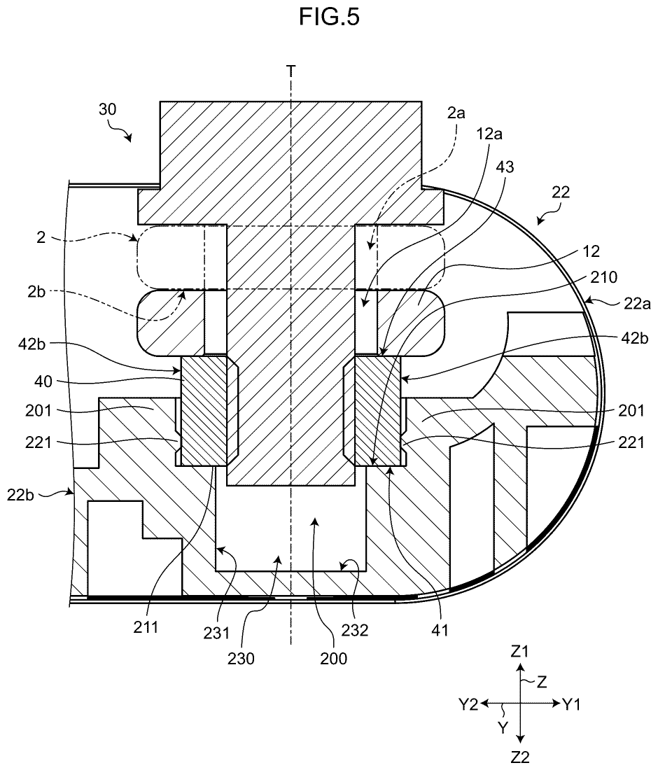

As illustrated in FIGS. 4 and 5, the nut holding portion 200 has a bottomed recess 230 that is formed in a recessed shape from the nut placement surface 210 to the opposite side of the bus bar 10 in the fastening direction T and is provided with a peripheral surface 231 connected to an inner edge 211 of the nut placement surface 210 formed in an annular shape. In the present embodiment, the bottomed recess 230 is a bottomed circular recess with a bottom surface 232 and is recessed from the nut placement surface 210 to the other side 22 in the height direction Z. As illustrated in FIGS. 3 and 4, an edge 203a of the inclined surface 203 on the other side X2 in the axial direction X is connected to the inner edge 211 of the annularly formed nut placement surface 210 (that is, an edge of the bottomed recess 230 on the one side Z1 in the height direction Z) in a state of approximately overlapping the inner edge 211. Accordingly, the edge 203a of the inclined surface 203 is in contact with a face 41 of the nut 40 to be described below on the other side Z2 in the height direction Z.

As illustrated in FIG. 4, the nut 40 is placed with its axis aligned in the fastening direction T and its face 41 on the other side Z2 in the height direction Z in close contact with the nut placement surface 210. More specifically, the face 41 of the nut 40 on the other side Z2 in the height direction Z is in close contact with the inner edge 211 of the nut placement surface 210 (the inner edge 211 including the edge 203a of the inclined surface 203). In other words, the inner edge 211 of the nut placement surface 210 is located outside of a diameter Da of a valley of a female thread of the nut 40 and within a projected area of the nut 40. In other words, the diameter Da of the valley of the female thread of the nut 40 is smaller than a diameter Db of the bottomed recess 230. Accordingly, the bottomed recess 230 is approximately sealed.

As described above, a side 42a of the nut 40 on the other side X2 in the axial direction X is in contact with a face 220a of the nut pressing portion 220 on the one side X1 in the axial direction X. As described above, as illustrated in FIG. 5, two sides 42b of the nut 40 in the width direction Y are in contact with the nut pressing protrusions 221 of the side wall 201, respectively. Accordingly, the nut 40 is interposed and fixed by the nut pressing protrusions 221 facing each other in the width direction Y. Accordingly, the nut 40 is held in the nut holding portion 200 of the housing 20. The fixing of the nut 40, which is a square nut, by the nut pressing protrusions 221 reduces that the nut 40 easily shifts to the one side Z1 in the height direction Z during and after fastening with the bolt 30. Accordingly, the contact state between the nut placement surface 210 and the face 41 of the nut 40 on the other side Z2 in the height direction Z in the fastened state with the bolt 30 is further reliably maintained.

As illustrated in FIG. 4, a face 43 of the nut 40 held in the nut holding portion 200 on the one side Z1 in the height direction Z is in close contact with a nut contact surface 12b that is a face of the second connection portion 12 of the bus bar 10 on the other side Z2 in the height direction Z. A distance D1 from the nut placement surface 210 to the nut contact surface 12b along the fastening direction T is equivalent to a height H1 of the nut 40 along the fastening direction T (also see FIG. 2). Accordingly, in the fastened state in which the bolt 30 is fastened to the nut 40 fixed to the nut holding portion 200, the face 41 of the nut 40 on the other side Z2 in the height direction Z is always in close contact with the nut placement surface 210.

Even in a configuration where the distance D1 is not equivalent to the height H1 of the nut 40, as long as the nut placement surface 210 and the face 41 of the nut 40 on the other side Z2 in the height direction Z are always in close contact with each other when the nut 40 and the bolt 30 are fastened together, other configurations can also be adopted. For example, the bolt 30 and the nut 40 can be fastened together with a spacer member such as a washer interposed between the face 43 of the nut 40 on the one side Z1 in the height direction Z and the nut contact surface 12b of the second connection portion 12 of the bus bar 10.

A face 12c of the second connection portion 12 of the bus bar 10 on the one side Z1 in the height direction Z is in contact with a face 2b of the external terminal 2 on the other side Z2 in the height direction Z. The axes of the connection hole 12a of the second connection portion 12 and the connection hole 2a of the external terminal 2 are aligned and the bolt 30 is inserted therethrough. Subsequently, the bolt 30 is screwed into and fastened to the nut 40. The nut 40 is prevented from rotating by the nut pressing protrusion 221. In this way, the external terminal 2 and the second connection portion 12 of the bus bar 10 are connected. The tip of the bolt 30 also enters the interior of the bottomed recess 230.

When the bolt 30 is screwed into the nut 40, foreign matters such as plating scum and burrs may be generated from the threads of the bolt 30 and the nut 40. In the terminal block 1 of the present embodiment, such foreign matters are stored within the bottomed recess 230. Since the bottomed recess 230 is approximately sealed, the possibility of foreign matters leaking out of the bottomed recess 230 is reduced.

The terminal block 1 described above includes the bus bar 10 extending in the axial direction X and connected to the external terminal 2, the nut 40 into which the bolt 30 is screwed, the bolt 30 fastening the bus bar 10 and the external terminal 2 along the fastening direction T that intersects the axial direction X, and the housing 20 having the nut holding portion 200 that holds the nut 40 and holding the bus bar 10. The nut holding portion 200 includes the nut placement surface 210 formed in an annular shape around the fastening direction T, with the nut 40 being placed on the nut placement surface 210, and the bottomed recess 230 that is formed in a recessed shape from the nut placement surface 210 to the opposite side of the bus bar 10 in the fastening direction T and is provided with the peripheral surface 231 connected to the inner edge 211 of the nut placement surface 210 formed in an annular shape.

Thus, the bottomed recess 230 formed in an approximately bag shape and the nut placement surface 210 are integrally formed with each other. Accordingly, no gap is generated between the nut placement surface 210 and the bottomed recess 230. In addition, the nut 40 can be placed in close contact with the nut placement surface 210, so that the bottomed recess 230 can be approximately sealed. Thus, in accordance with the terminal block 1 according to the present embodiment, the possibility of foreign matters stored in the bottomed recess 230 being scattered out of the terminal block 1 due to vibration or the like can be properly reduced. In the nut holding portion 200, since the nut placement surface 210 and the bottomed recess 230 are integrally formed with each other, the number of parts does not need to be increased to properly reduce the scattering of foreign matters, thereby preventing an increase in costs and the weight of the terminal block 1. Moreover, each nut holding portion 200 can be provided for each bus bar 10, thereby easily coping with an increase or decrease in the number of the bus bars 10.

The nut 40 is in contact with the nut placement surface 210 when fastened to the bolt 30. This ensures that the nut 40 and the nut placement surface 210 can be reliably brought into contact with each other even when the bolt 30 and the nut 40 are fastened together and moreover, the scattering of foreign matters stored in the bottomed recess 230 can be properly reduced.

The bus bar 10 includes the nut contact surface 12b in contact with the nut 40, and the distance D1 from the nut placement surface 210 to the nut contact surface 12b along the fastening direction T is equivalent to the height H1 of the nut 40 along the fastening direction T. Thus, the nut 40 and the nut placement surface 210 can be brought into close contact with each other without using a spacer member such as a washer between the nut 40 and the bus bar 10, and the bus bar 10 and the nut 40 can also be further brought into close contact with each other, thereby properly reducing the scattering of foreign matters stored in the bottomed recess 230 more reliably.

The nut holding portion 200 is formed integrally with the housing 20. This can eliminate the need to further increase the number of parts and reduce an increase in costs and the weight of the terminal block 1.

The terminal block according to the embodiment of the present invention described above is not limited to the embodiment described above, and various changes can be made within the scope of the claims.

In the above description, the nut holding portion 200 is assumed to be integrally formed with the housing 20; however, the present embodiment is not limited thereto and for example, the nut holding portion 200 alone, as a separate component, may be assembled to the bus bar holding portion 22. The bottomed recess 230 is formed in an approximately circular recessed shape, but can also be a bottomed recess having other shapes such as a rectangular shape.

The terminal block according to the present embodiment may be configured by combining components of the embodiment and modifications described above as appropriate.

The terminal block according to the present invention is effective in properly reducing the scattering of foreign matters.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar extending in an axial direction and connected to an external terminal;
a nut into which a bolt is screwed, the bolt fastening the bus bar and the external terminal along a fastening direction that intersects the axial direction; and
a housing including a nut holding portion that holds the nut, and holding the bus bar, wherein
the nut holding portion includes:
a nut placement surface formed in an annular shape around the fastening direction, with the nut being placed on the nut placement surface; and
a bottomed recess that is formed in a recessed shape from the nut placement surface to an opposite side of the bus bar in the fastening direction and is provided with a peripheral surface connected to an inner edge of the nut placement surface formed in an annular shape.

2. The terminal block according to claim 1, wherein
the nut is in contact with the nut placement surface when fastened to the bolt.

3. The terminal block according to claim 1, wherein
the bus bar includes a nut contact surface in contact with the nut, and
a distance from the nut placement surface to the nut contact surface along the fastening direction is equivalent to a height of the nut along the fastening direction.

4. The terminal block according to claim 2, wherein
the bus bar includes a nut contact surface in contact with the nut, and
a distance from the nut placement surface to the nut contact surface along the fastening direction is equivalent to a height of the nut along the fastening direction.

5. The terminal block according to claim 1, wherein
the nut holding portion is integrally formed with the housing.

6. The terminal block according to claim 2, wherein
the nut holding portion is integrally formed with the housing.
